(19) United States
(12) Patent Application Publication
(10) Pub. No.: US 2022/0402029 A1
(43) Pub. Date: Dec. 22, 2022

(54) FINE PARTICLE PRODUCTION DEVICE AND FINE PARTICLE PRODUCTION METHOD

(71) Applicant: NISSHIN ENGINEERING INC., Tokyo (JP)

(72) Inventors: Shu WATANABE, Fujimino-city (JP); Shiori SUEYASU, Fujimino-city (JP); Keitaro NAKAMURA, Fujimino-city (JP)

(21) Appl. No.: 17/777,196

(22) PCT Filed: Nov. 10, 2020
(86) PCT No.: PCT/JP2020/041941

§ 371 Date: May 16, 2022

(30) Foreign Application Priority Data
Nov. 18, 2019 (JP) 2019-208105

(51) Int. Cl. B22F 9/08; C09C 3/08; C09C 1/62; B22F 1/14

(52) U.S. Cl. CPC B22F 9/08; C09C 3/08; C09C 1/627; B22F 1/14; B22F 2301/10

(57) ABSTRACT

Provided is a fine particle production apparatus and a fine particle production method capable of easily obtaining surface treated fine particles. The fine particle production apparatus produces fine particles using feedstock by means of a gas-phase process. The apparatus includes a treatment section configured to transform the feedstock into a mixture in a gas phase state by means of the gas-phase process, a feedstock supply section configured to supply the feedstock to the treatment section, a cooling section configured to cool the mixture in a gas phase state in the treatment section using a quenching gas containing an inert gas, and a supply section configured to supply a surface treating agent to fine particle bodies in a temperature region in which the surface treating agent is not denatured, the fine particle bodies being produced by cooling the mixture in the gas phase state with the quenching gas.

### TECHNICAL FIELD

The present invention relates to a fine particle production apparatus and a fine particle production method for producing fine particles with a particle size of 10 to 200 nm, particularly to a fine particle production apparatus for producing surface treated fine particles and a production method of the same.

### BACKGROUND ART

At present, various types of fine particles are used in various applications. For instance, fine particles such as metal fine particles, oxide fine particles, nitride fine particles, and carbide fine particles have been used in electrical insulation materials for various electrical insulation parts, cutting tools, materials for machining tools, functional materials for sensors, sintered materials, electrode materials for fuel cells, and catalysts.

To the various types of fine particles described above, surface coating is formed for the purpose of suppressing oxidation of the fine particles or providing an additional function.

For example, Patent Literature 1 provides titanium metal fine particles whose surfaces are coated with a compound of an organic acid and titanium, and a production method of the same.

In Patent Literature 1, metal fine particles are produced by, in an atmosphere including vapor or mist of a carboxylic acid having 1 to 18 carbon atoms, electrically heating a thin metal wire with a diameter of 0.05 to 1.0 mm formed of metal containing 81 to 100 mol % of titanium for 0.1 to 100 microseconds to apply energy of 1.5 to 5.0 times the evaporation energy of the thin metal wire.

Patent Literature 2 provides coated copper particles including copper particles and a coating layer containing an aliphatic carboxylic acid disposed on surfaces of the copper particles at a density of not less than 2.5 molecules and not more than 5.2 molecules per 1 nm², and a production method of the same.

In Patent Literature 2, when an aliphatic carboxylic acid copper complex is subjected to thermal decomposition, copper ions are reduced, and metal copper particles are generated. Subsequently, an aliphatic carboxylic acid is, for example, physically adsorbed to surfaces of the generated metal copper particles to form a coating layer containing an aliphatic carboxylic acid at a predetermined coating density, whereby the desired coated copper particles are obtained.

### CITATION LIST

### Patent Literature

Patent Literature 1: JP 2010-209417 A
Patent Literature 2: WO 2016/052275

### SUMMARY OF INVENTION

### Technical Problems

As above, the production method of titanium metal fine particles of Patent Literature 1 requires to electrically heat a thin metal wire in an atmosphere containing vapor or mist of a carboxylic acid having 1 to 18 carbon atoms for 0.1 to 100 microseconds. The production method of coated copper particles of Patent Literature 2 requires to thermally decompose an aliphatic carboxylic acid copper complex. Patent Literatures 1 and 2 both require heating or another treatment to produce fine particles having surface coatings, with the necessity of a large amount of energy and enlargement of an apparatus. In addition, the production process becomes complicate. Under the circumstances, it is not easy to obtain fine particles with surface coating or other surface treated fine particles.

An object of the present invention is to provide a fine particle production apparatus and a fine particle production method capable of easily obtaining surface treated fine particles.

### Solution to Problems

In order to attain the above-described object, the present invention provides a fine particle production apparatus for producing fine particles using feedstock by means of a gas-phase process, the apparatus comprising: a treatment section configured to transform the feedstock into a mixture in a gas phase state by means of the gas-phase process; a feedstock supply section configured to supply the feedstock to the treatment section; a cooling section configured to cool the mixture in the gas phase state in the treatment section using a quenching gas containing an inert gas; and a supply section configured to supply a surface treating agent to fine particle bodies in a temperature region in which the surface treating agent is not denatured, the fine particle bodies being produced by cooling the mixture in the gas phase state with the quenching gas.

The gas-phase process is preferably a thermal plasma process or a flame process.

For instance, the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution. In addition, for instance, the feedstock is copper powder.

The feedstock supply section preferably supplies the feedstock to the treatment section with the feedstock being dispersed in a particulate form. The feedstock supply section also preferably disperses the feedstock in liquid to obtain a slurry and transforms the slurry into droplets to supply the droplets to the treatment section.

The present invention provides a fine particle production method for producing fine particles using feedstock by means of a gas-phase process, the method comprising: a step of producing fine particle bodies by transforming the feedstock into a mixture in a gas phase state by means of a gas-phase process and cooling the mixture in the gas phase state using a quenching gas containing an inert gas; and a step of supplying a surface treating agent to the fine particle bodies in a temperature region in which the surface treating agent is not denatured.

The gas-phase process is preferably a thermal plasma process or a flame process.

For instance, the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution. In addition, for instance, the feedstock is copper powder.

In the step of producing the fine particle bodies, preferably, the feedstock is transformed into the mixture in the gas phase state using a thermal plasma flame, and the feedstock is supplied into the thermal plasma flame with the feedstock being dispersed in a particulate form. In addition, in the step of producing the fine particle bodies, preferably, the feedstock is transformed into the mixture in the gas phase state using a thermal plasma flame, where the feedstock is dispersed in liquid to obtain a slurry, and the slurry is transformed into droplets and supplied into the thermal plasma flame.

### Advantageous Effects of Invention

The fine particle production apparatus and the fine particle production method according to the invention make it possible to easily obtain surface treated fine particles.

### BRIEF DESCRIPTION OF DRAWINGS

FIG. 1 is a schematic view showing an example of a fine particle production apparatus that is used in a fine particle production method according to the invention.

FIG. 2 is a schematic view showing an example of fine particles obtained by the fine particle production method according to the invention.

FIG. 3 is a graph showing percentages of removed surface coating on the fine particles obtained by the fine particle production method according to the invention.

### DESCRIPTION OF EMBODIMENTS

A fine particle production apparatus and a fine particle production method according to the present invention are described below in detail based on a preferred embodiment shown in the accompanying drawings.

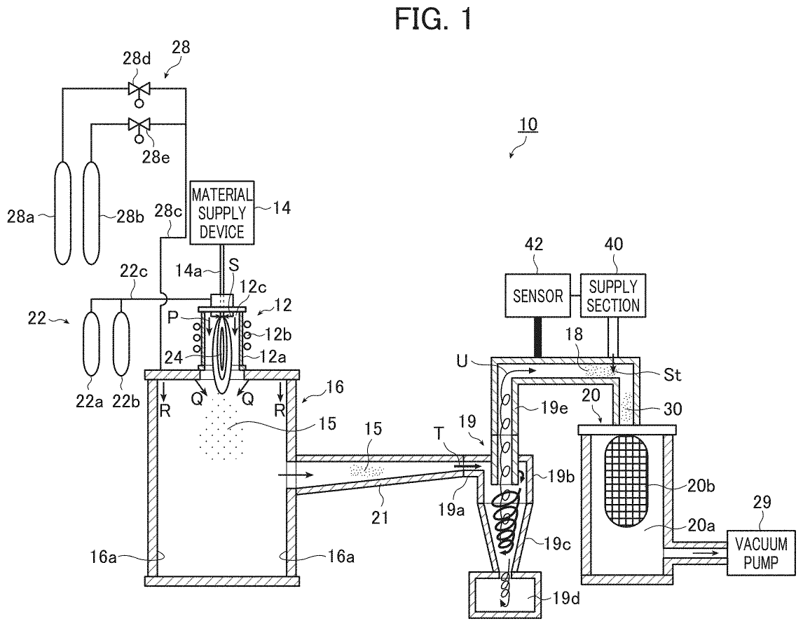

Hereinafter, an example of the fine particle production apparatus and the fine particle production method according to the invention is described, but the invention is not limited to the production apparatus and the production method shown in FIG. 1.

FIG. 1 is a schematic view showing an example of a fine particle production apparatus that is used in the fine particle production method according to the invention. A fine particle production apparatus 10 (hereinafter referred to simply as “production apparatus 10”) shown in FIG. 1 is used to produce surface treated fine particles 30. The surface treated fine particles 30 can be easily obtained by the production apparatus 10.

The surface treated fine particles 30 produced by the production apparatus 10 are not particularly limited in type. In the production apparatus 10, a surface treating agent is supplied to various types of fine particles including metal fine particles, oxide fine particles, nitride fine particles, carbide fine particles, and oxynitride fine particles that are obtained by varying the composition of feedstock, whereby the surface treated fine particles 30 can be produced. Hereinbelow, the surface treated fine particles 30 are also simply called fine particles 30.

The production apparatus 10 includes a plasma torch 12 generating a thermal plasma flame, a material supply device 14 supplying feedstock powder of fine particles into the plasma torch 12, a chamber 16 serving as a cooling tank for use in producing primary fine particles 15, a cyclone 19 removing, from the produced primary fine particles 15, coarse particles having a particle size equal to or larger than an arbitrarily specified particle size, and a collecting section 20 collecting secondary fine particles 18 having a desired particle size as obtained by classification by the cyclone 19. The production apparatus 10 further includes a supply section 40 supplying a surface treating agent to the secondary fine particles 18, and a sensor 42 measuring temperature of a transport path of the secondary fine particles 18.

The primary fine particles 15 and the secondary fine particles 18 are both fine particle bodies in the middle of the production process of the fine particles of the invention. Those obtained by surface treating the secondary fine particles 18, i.e., the surface treated fine particles 30 are the fine particles of the invention.

Various devices in, for example, JP 2007-138287 A may be used for the material supply device 14, the chamber 16, the cyclone 19, and the collecting section 20.

In the embodiment, for example, copper powder is used as the feedstock in the production of the fine particles. In this case, the fine particles 30 finally obtained, the primary fine particles 15, and the secondary fine particles 18 are constituted of copper.

The average particle size of copper powder is appropriately set to allow easy evaporation of the powder in a thermal plasma flame. The average particle size of copper powder is measured by a laser diffraction method and is, for example, not larger than 100 μm, preferably not larger than 10 μm, and more preferably not larger than 5 μm. The feedstock is not limited to copper, but other metal powder than copper powder can be used, and alloy powder can also be used.

The plasma torch 12 is constituted of a quartz tube 12a and a coil 12b for high frequency oscillation surrounding the outside of the quartz tube. A supply tube 14a to be described later which is for supplying feedstock powder of the fine particles into the plasma torch 12 is provided on the top of the plasma torch 12 at the central part thereof. A plasma gas supply port 12c is formed in the peripheral portion of the supply tube 14a (on the same circumference). The plasma gas supply port 12c is in a ring shape. To the coil 12b for high frequency oscillation, a power source (not shown) that generates a high frequency voltage is connected. When a high frequency voltage is applied to the coil 12b for high frequency oscillation, a thermal plasma flame 24 is generated. The feedstock (not shown) is evaporated by the thermal plasma flame 24 and transformed into a mixture in a gas phase state. The plasma torch 12 constitutes a treatment section transforming the feedstock into a mixture in a gas phase state by means of a gas-phase process in the invention.

A plasma gas supply source 22 is configured to supply plasma gas into the plasma torch 12 and for instance has a first gas supply section 22a and a second gas supply section 22b. The first gas supply section 22a and the second gas supply section 22b are connected to the plasma gas supply port 12c through piping 22c. Although not shown, the first gas supply section 22a and the second gas supply section 22b are each provided with a supply amount adjuster such as a valve for adjusting the supply amount. Plasma gas is supplied from the plasma gas supply source 22 into the plasma torch 12 through the plasma gas supply port 12c of ring shape in the direction indicated by arrow P and the direction indicated by arrow S.

For example, mixed gas of hydrogen gas and argon gas is used as plasma gas. In this case, hydrogen gas is stored in the first gas supply section 22a, while argon gas is stored in the second gas supply section 22b. Hydrogen gas is supplied from the first gas supply section 22a of the plasma gas supply source 22 and argon gas is supplied from the second gas supply section 22b thereof into the plasma torch 12 in the direction indicated by arrow P and the direction indicated by arrow S after passing through the piping 22c and then the plasma gas supply port 12c. Argon gas may be solely supplied in the direction indicated by arrow P.

As the plasma gas, a gas is selected for use depending on the fine particles; it is not essential to use mixed gas as described above, and one kind of gas may be used as the plasma gas.

When a high frequency voltage is applied to the coil 12b for high frequency oscillation, the thermal plasma flame 24 is generated in the plasma torch 12.

It is necessary for the thermal plasma flame 24 to have a higher temperature than the boiling point of the feedstock powder. A higher temperature of the thermal plasma flame 24 is more preferred because the feedstock powder is more easily transformed into a gas phase state; however, there is no particular limitation on the temperature. For instance, the thermal plasma flame 24 may have temperature of 6,000° C., and in theory, the temperature is deemed to reach around 10,000° C.

The ambient pressure inside the plasma torch 12 is preferably up to atmospheric pressure. For the atmosphere at a pressure up to atmospheric pressure, the pressure is not particularly limited and is, for example, in the range of 0.5 to 100 kPa.

The periphery of the quartz tube 12a is surrounded by a concentrically formed tube (not shown), and cooling water is circulated between this tube and the quartz tube 12a to cool the quartz tube 12a with the water, thereby preventing the quartz tube 12a from having an excessively high temperature due to the thermal plasma flame 24 generated in the plasma torch 12.

The material supply device 14 is connected to the top of the plasma torch 12 through the supply tube 14a. The material supply device 14 is configured to supply the feedstock into the thermal plasma flame 24 in the plasma torch 12. The material supply device 14 is a feedstock supply section of the invention.

The type of the material supply device 14 is not particularly limited as long as it can supply the feedstock into the thermal plasma flame 24, and, for example, the following two types are applicable: one supplying the feedstock into the thermal plasma flame 24 with the feedstock being dispersed in a particulate form, and one slurrying the feedstock and transforming the obtained slurry into droplets to supply the droplets into the thermal plasma flame 24.

When the feedstock is powder, for instance, as described above, the device disclosed in JP 2007-138287 A may be used as the material supply device 14 that supplies the feedstock, e.g., copper powder in a powdery form. In this case, the material supply device 14 includes, for example, a storage tank (not shown) storing the feedstock, a screw feeder (not shown) transporting the feedstock in a fixed amount, a dispersion section (not shown) dispersing the feedstock transported by the screw feeder to transform it into the form of primary particles before the feedstock is finally sprayed, and a carrier gas supply source (not shown).

Together with carrier gas to which push-out pressure is applied from the carrier gas supply source, the feedstock is supplied into the thermal plasma flame 24 in the plasma torch 12 through the supply tube 14a.

The configuration of the material supply device 14 is not particularly limited as long as the device can prevent the feedstock from agglomerating, thus making it possible to spray the feedstock in the plasma torch 12 with the dispersed state maintained. Inert gas such as argon gas is used as the carrier gas, for example. The flow rate of the carrier gas can be controlled using, for instance, a flowmeter such as a float type flowmeter. The flow rate value of the carrier gas is indicated by a reading on the flowmeter.

For example, the device disclosed in JP 2011-213524 A may be used as the material supply device 14 which supplies the feedstock in the form of slurry. In this case, the feedstock supply device 14 includes a vessel (not shown) storing a slurry (not shown) having powdery feedstock dispersed in liquid such as water, an agitator (not shown) agitating the slurry in the vessel, a pump (not shown) applying high pressure to the slurry to supply the slurry into the plasma torch 12 through the supply tube 14a, and a spray gas supply source (not shown) supplying spray gas used to transform the slurry into droplets and supply the droplets into the plasma torch 12. The spray gas supply source corresponds to the carrier gas supply source. The spray gas is also called carrier gas.

In the case where the feedstock is supplied in the form of slurry, powdery feedstock is dispersed in liquid such as water to obtain a slurry. The mixing ratio between the powdery feedstock and water in the slurry is not particularly limited and is, for example, 5:5 (50%:500) in the mass ratio.

In the case of using the material supply device 14 slurrying the powdery feedstock and supplying the obtained slurry in the form of droplets, spray gas to which push-out pressure is applied from the spray gas supply source is, together with the slurry, supplied into the thermal plasma flame 24 in the plasma torch 12 through the supply tube 14a. The supply tube 14a has a two-fluid nozzle mechanism for spraying the slurry to the thermal plasma flame 24 in the plasma torch and transforming it into droplets, and using this mechanism, the slurry is sprayed into the thermal plasma flame 24 in the plasma torch 12. That is, this makes it possible to transform the slurry into droplets. Similarly to the carrier gas described above, inert gases such as argon gas (Ar gas) and nitrogen gas are usable as the spray gas, for example.

Thus, the two-fluid nozzle mechanism is capable of applying a high pressure to the slurry and spraying the slurry with gas, i.e., the spray gas (carrier gas), and is used as a method for transforming the slurry into droplets.

It should be noted that the nozzle mechanism is not limited to the two-fluid nozzle mechanism as above, and a single-fluid nozzle mechanism may also be used. As other methods, examples include a method which involves allowing a slurry to fall onto a rotating disk at a constant rate to transform the slurry into droplets (to form droplets) by the centrifugal force and a method which involves applying high voltage to a surface of a slurry to transform the slurry into droplets (to generate droplets). An exemplary feedstock slurry is an alcohol slurry of titanium oxide.

The chamber 16 is provided below and adjacent to the plasma torch 12, and a gas supply device 28 is connected to the chamber 16. The primary fine particles 15 of copper, for example, are produced in the chamber 16. The chamber 16 serves as a cooling tank.

The gas supply device 28 is configured to supply a cooling gas (quenching gas) including an inert gas into the chamber 16. The thermal plasma flame 24 evaporates the feedstock and transforms it into a mixture in a gas phase state, and the gas supply device 28 supplies a cooling gas (quenching gas) containing an inert gas to the mixture.

The gas supply device 28 has a first gas supply source 28a, a second gas supply source 28b, and piping 28c, for example. The gas supply device 28 further includes a pressure application apparatus (not shown) such as a compressor or a blower which applies push-out pressure to the cooling gas to be supplied into the chamber 16. The gas supply device 28 is a cooling section of the invention.

The gas supply device 28 is also provided with a pressure control valve 28d which controls an amount of gas supplied from the first gas supply source 28a and a pressure control valve 28e which controls an amount of gas supplied from the second gas supply source 28b. For example, the first gas supply source 28a stores argon gas. In this case, the cooling gas is argon gas. Here, the second gas supply source 28b can store gas that is different from the gas stored by the first gas supply source 28a. In this case, mixed gas of the gas stored by the first gas supply source 28a and the gas stored by the second gas supply source 28b is the cooling gas (quenching gas). For example, when the second gas supply source 28b stores methane gas, the cooling gas (quenching gas) is mixed gas of argon gas and methane gas.

The gas supply device 28 supplies argon gas as the cooling gas at, for example, 45 degrees in the direction of arrow Q toward a tail portion of the thermal plasma flame 24, i.e., the end of the thermal plasma flame 24 on the opposite side from the plasma gas supply port 12c, that is, a terminating portion of the thermal plasma flame 24, and also supplies the cooling gas from above to below along an inner wall 16a of the chamber 16, that is, in the direction of arrow R shown in FIG. 1.

The cooling gas supplied from the gas supply device 28 into the chamber 16 quenches the copper powder having been evaporated and transformed to a mixture in a gas phase state by the thermal plasma flame 24, thereby obtaining the primary fine particles 15 of copper. Besides, the cooling gas has additional functions such as contribution to classification of the primary fine particles 15 in the cyclone 19. The cooling gas is, for instance, argon gas.

When the primary fine particles 15 of copper having just been produced collide with each other to form agglomerates, this causes nonuniform particle size, resulting in lower quality. However, dilution of the primary fine particles 15 with argon gas supplied as the cooling gas in the direction of arrow Q toward the tail portion (terminating portion) of the thermal plasma flame prevents the fine particles from colliding with each other to agglomerate together.

In addition, argon gas supplied as the cooling gas in the direction of arrow R prevents the primary fine particles 15 from adhering to the inner wall 16a of the chamber 16 in the process of collecting the primary fine particles 15, whereby the yield of the produced primary fine particles 15 is improved.

While argon gas is used for the cooling gas (quenching gas), the invention is not limited thereto; another inert gas than argon gas can be used, and nitrogen gas, for example, can be used. In addition, the cooling gas is not limited to an inert gas, and use can be made of air, oxygen or carbon dioxide.

In addition, not only argon gas or another gas described above but also a hydrocarbon gas having 4 or less carbon atoms, for example, can be used for the cooling gas (quenching gas). Hence, for the cooling gas (quenching gas), paraffinic hydrocarbon gases such as methane (CH₄), ethane (C₂H₆), propane (C₃H₈), and butane (C₄H₁₀), and olefinic hydrocarbon gases such as ethylene (C₂H₄), propylene (C₃H₆), and butylene (C₄H₈) can be used.

As shown in FIG. 1, the cyclone 19 is provided to the chamber 16 to classify the primary fine particles 15 of copper based on a desired particle size. The cyclone 19 includes an inlet tube 19a which supplies the primary fine particles 15 from the chamber 16, a cylindrical outer tube 19b connected to the inlet tube 19a and positioned at an upper portion of the cyclone 19, a truncated conical part 19c continuing downward from the bottom of the outer tube 19b and having a gradually decreasing diameter, a coarse particle collecting chamber 19d connected to the bottom of the truncated conical part 19c for collecting coarse particles having a particle size equal to or larger than the above-mentioned desired particle size, and an inner tube 19e connected to the collecting section 20 to be detailed later and projecting from the outer tube 19b. The chamber 16 is connected to the inlet tube 19a via a connection tube 21, and the primary fine particles 15 move to the cyclone 19 through the connection tube 21. The connection tube 21 is the transport path of the primary fine particles 15.

A gas stream containing the primary fine particles 15 is blown from the inlet tube 19a of the cyclone 19 to flow along the inner peripheral wall of the outer tube 19b, and accordingly, this gas stream flows in the direction from the inner peripheral wall of the outer tube 19b toward the truncated conical part 19c as indicated by arrow T in FIG. 1, thus forming a downward swirling stream.

When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged to the outside of the cyclone 19 through the inner tube 19e along with the upward stream on the inner wall of the truncated conical part 19c.

The apparatus is configured such that a negative pressure (suction force) is exerted from the collecting section 20 to be detailed later through the inner tube 19e. Due to the negative pressure (suction force), the fine particles separated from the swirling gas stream are sucked as indicated by arrow U and sent to the collecting section 20 through the inner tube 19e.

On the extension of the inner tube 19e which is an outlet for the gas stream in the cyclone 19, the collecting section 20 for collecting the fine particles 30 having a desired particle size on the order of nanometers is provided. The collecting section 20 includes a collecting chamber 20a, a filter 20b provided in the collecting chamber 20a, and a vacuum pump 29 connected through a tube provided at a lower portion of the collecting chamber 20a. The fine particles 30 delivered from the cyclone 19 are sucked by the vacuum pump 29 to be introduced into the collecting chamber 20a, and remain on the surface of the filter 20b and are then collected.

It should be noted that the number of cyclones used in the production apparatus 10 is not limited to one and may be two or more.

The supply section 40 supplies a surface treating agent St to the fine particle bodies (secondary fine particles 18) in a temperature region in which the surface treating agent is not denatured. As shown in FIG. 1, the supply section 40 is provided to the inner tube 19e in the vicinity of the collecting section 20. The supply section 40 supplies the surface treating agent St to the secondary fine particles 18 passing through the inner tube 19e. With this configuration, the surface treating agent St adheres to the secondary fine particles 18 to surface treat the secondary fine particles 18, whereby the fine particles 30 having the properties based on the surface treating agent St are obtained.

The method for supplying the surface treating agent St with the supply section 40 is not particularly limited, and in an exemplary method, the surface treating agent St is transformed into droplets and sprayed to the secondary fine particles 18.

As described above, the surface treating agent St is supplied in a temperature region in which the agent is not denatured. In a temperature region in which the agent is not denatured, the surface treating agent St does not decompose due to heat or another factor, and the properties of the surface treating agent St do not change. Hence, the properties of the surface treating agent St are kept in the fine particles 30, and the fine particles 30 have the properties based on the surface treating agent St.

The above-described temperature region in which the surface treating agent St is not denatured means a temperature region determined from the temperature measurement by the thermogravimeter-differential thermal analysis (TG-DTA).

The temperature region in which the surface treating agent St is not denatured is defined as a temperature region where the weight loss ratio is not more than 50 wt % in the thermogravimeter-differential thermal analysis of the surface treating agent St. The weight loss ratio is preferably not more than 30 wt %, and further preferably not more than 10 wt %.

The surface treating agent St is preferably denatured as little as possible, and when the weight loss ratio in the thermogravimeter-differential thermal analysis exceeds 50 wt %, the influence from denaturation of the surface treatment agent can no longer be ignored in some cases. To minimize the influence from denaturation of the surface treating agent, the weight loss ratio is preferably not more than 30 wt %, and further preferably not more than 10 wt %, as described above.

In the thermogravimeter-differential thermal analysis, STA7200 (trade name) of Hitachi High-Technologies Corporation is used.

The surface treating agent St is not particularly limited and is, for example, an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, or a basic substance alone or a basic substance solution. In addition to the foregoing, a natural resin alone or a natural resin solution and a synthetic resin alone or a synthetic resin solution can also be used for the surface treating agent St.

An organic acid that is in the form of liquid when used can be alone usable and is not necessarily required to be dissolved in a solvent to form an aqueous solution. When use is made of the surface treating agent St constituted of an acidic substance aside from an organic acid, a basic substance, a natural resin, a synthetic resin or another substance, the substance can be alone usable as long as the substance is in the form of liquid when used, as with the case of an organic acid.

### (Dispersant Alone and Dispersant Solution)

Examples of the dispersant for use include a dispersant having only amine value, a dispersant having only acid value, and a dispersant having amine value and acid value. The dispersant can make use of the followings. When the dispersant has amine value, the amine value of the dispersant is preferably not less than 10 and not more than 100, and more preferably not less than 10 and not more than 60.

Examples of dispersant having only amine value include DISPERBYK-102, DISPERBYK-160, DISPERBYK-161, DISPERBYK-162, DISPERBYK-2163, DISPERBYK-2164, DISPERBYK-166, DISPERBYK-167, DISPERBYK-168, DISPERBYK-2000, DISPERBYK-2050, DISPERBYK-2150, DISPERBYK-2155, DISPERBYK-LPN6919, DISPERBYK-LPN21116, DISPERBYK-LPN21234, DISPERBYK-9075, and DISPERBYK-9077 (produced by BYK-Chemie); EFKA 4015, EFKA 4020, EFKA 4046, EFKA 4047, EFKA 4050, EFKA 4055, EFKA 4060, EFKA 4080, EFKA 4300, EFKA 4330, EFKA 4340, EFKA 4400, EFKA 4401, EFKA 4402, EFKA 4403, and EFKA 4800 (produced by BASF); and AJISPER (registered trademark) PB711 (produced by Ajinomoto Fine-Techno Co., Inc.).

Examples of polymer dispersant having amine value and acid value include DISPERBYK-142, DISPERBYK-145, DISPERBYK-2001, DISPERBYK-2010, DISPERBYK-2020, DISPERBYK-2025, DISPERBYK-9076, and Anti-Terra-205 (produced by BYK-Chemie); SOLSPERSE 24000 (produced by Lubrizol Corporation); AJISPER (registered trademark) PB821, AJISPER-PB880, and AJISPER PB881 (produced by Ajinomoto Fine-Techno Co., Inc.).

Examples of dispersant having only acid value include DISPERBYK-110, DISPERBYK-111, DISPERBYK-170, DISPERBYK-171, and DISPERBYK-174 (produced by BYK-Chemie); BYK-P104, BYK-P104S, BYK-P105, and BYK-220S (produced by BYK-Chemie); EFKA 5010, EFKA 5065, EFKA 5066, and EFKA 5070 (produced by BASF); SOLSPERSE 3000, SOLSPERSE 16000, SOLSPERSE 17000, SOLSPERSE 18000, SOLSPERSE 21000, SOLSPERSE 27000, SOLSPERSE 28000, SOLSPERSE 36000, SOLSPERSE 36600, SOLSPERSE 38500, SOLSPERSE 39000, and SOLSPERSE 41000 (produced by Lubrizol Corporation); and AJISPER (registered trademark) PN-411, and AJISPER PA-ill (produced by Ajinomoto Fine-Techno Co., Inc.).

### (Silane Coupling Agent Alone and Silane Coupling Agent Solution)

The silane coupling agent is exemplified by those represented by the formula below. In the below formula, X represents an organic reactive group such as an amino group, an epoxy group, a mercapto group, a methacryl group, or a vinyl group. Y represents an inorganic reactive group, i.e., a reactive group with the general formula (—OR), and R represents a same or different saturated alkyl group having 1 to 3 carbon atoms. Meanwhile, n is an integer of 1 to 3.

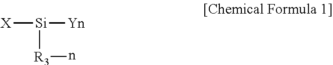

Specific examples of the silane coupling agent include vinyltrimethoxysilane, vinyltriethoxysilane, vinyl-tri(2-methoxyethoxy)silane, vinyltrichlorosilane, γ-methacryloxypropyltrimethoxysilane, γ-methacryloxypropyltriethoxysilane, γ-aminopropyltrimethoxysilane, γ-mercaptopropyltrimethoxysilane, and bis(3-triethoxysilylpropyl)tetrasulfen.

The silane coupling agent solution is, for example, a solution containing the forgoing silane coupling agent. The silane coupling agent content in the solution is not particularly limited and is appropriately determined depending on the application or another factor.

### (Organic Solvent)

The organic solvent is not particularly limited and can be appropriately selected according to the intended purpose. Examples of the organic solvent include alcohols including methanol, ketones including acetone, alkyl halides, amides including formamide, sulfoxides including dimethyl sulfoxide, a heterocyclic compound, hydrocarbons, esters including ethyl acetate, and ethers. One kind thereof may be used alone, or two or more kinds thereof may be used in combination.

### (Acidic Substance Alone and Acidic Substance Solution)

Examples of the acidic substance include acids such as hydrochloric acid, nitric acid, formic acid, acetic acid, and sulfuric acid.

The acidic substance solution is, for example, a solution containing the forgoing acidic substance. The acidic substance content in the solution is not particularly limited and is appropriately determined depending on the application or another factor.

### (Basic Substance Alone and Basic Substance Solution)

Examples of basic substance include amines including ammonia, monoethanolamine, diethanolamine, triethanoleamine, methylamine, dimethylamine, ethylamine, diethylamine, trimethylamine, triethylamine, guanidine, picoline, aniline, pyridine, piperidine, morpholine, N-methylaniline, toluidine, N, N-dimethyl-p-toluidine; alkali metal hydroxides including sodium hydroxide, and potassium hydroxide; and metal alkoxides including sodium methoxide, sodium ethoxide, and sodium butoxide. Among these, amines such as ammonia and monoethanolamine that are weakly basic are preferred, and monoethanolamine is most preferred.

### (Organic Acid Alone and Organic Acid Solution)

When an organic acid being an acidic substance is used for the surface treating agent, a solution is formed using pure water as a solvent, for example, and the solution is sprayed from the supply section 40. In this case, the organic acid is soluble in water, preferably has a low boiling point, and is preferably constituted only of C, O and H. As the organic acid, use can be made of, for instance, L-ascorbic acid (C₆H₈O₆), formic acid (CH₂O₂), glutaric acid (C₅H₈O₄), succinic acid (C₄H₆O₄), oxalic acid (C₂H₂O₄), DL-tartaric acid (C₄H₆O₆), lactose monohydrate, maltose monohydrate, maleic acid (C₄H₄O₄), D-mannite (C₆H₁₄O₆), citric acid (C₆H₈O₇), malic acid (C₄H₆O₅), malonic acid (C₃H₄O₄), and aliphatic carboxylic acid. Use of at least one of the foregoing organic acids is preferred.

For the spray gas used to transform the aqueous organic acid solution into droplets, argon gas is adopted for instance, but the spray gas is not limited to argon gas and may be inert gas such as nitrogen gas.

### (Natural Resin Alone and Natural Resin Solution)

Examples of the natural resin include pine resin, shellac, copal, dammar, mastic, dragon's blood, storax, copaiba balsam, elemi, frankincense, myrrh, and opopanax.

### (Synthetic Resin Alone and Synthetic Resin Solution)

Examples of the synthetic resin include phenolic resin, urea resin, melamine resin, unsaturated polyester resin, polyurethane, diallyl phthalate resin, silicone resin, alkyd resin, epoxy resin, polyethylene, polypropylene, polystyrene, acrylonitrile-styrene resin, acrylonitrile-butadiene-styrene resin, polyvinyl chloride, methacryl resin, polyethylene terephthalate, polyamide, polyacetal, polycarbonate, modified polyphenylene ether, polybutylene terephthalate, polyphenylene sulfide, polyimide, polyetherimide, polyarylate, polysulfone, polyether sulfone, polyetheretherketone, polytetrafluoroethylene, fluororesin, polymethyl terpene, isoprene rubber, butadiene rubber, chloroprene rubber, styrene-butadiene rubber, acrylonitrile-butadiene rubber, butyl rubber, urethane rubber, silicon rubber and acrylic rubber.

The sensor 42 measures temperature of the transport path of the secondary fine particles 18, and the temperature measurement result is utilized in determination of whether it falls in a temperature region in which the surface treating agent St is not denatured.

In this process, the temperature measurement result is output to the supply section 40, for example. The supply section 40 can determine whether it falls in a temperature region in which the surface treating agent St is not denatured based on the temperature measurement result of the transport path of the secondary fine particles 18 obtained by the sensor 42. When the temperature of the transport path of the secondary fine particles 18 falls in a temperature region in which the surface treating agent St is denatured, for example, the conditions for producing the primary fine particles 15 in the production apparatus 10 are altered.

Since the temperature measurement result obtained by the sensor 42 is utilized in determination of whether it falls in a temperature region in which the surface treating agent St is not denatured as described above, the sensor 42 is preferably provided on the upstream side in the transport direction of the secondary fine particles 18 and in the vicinity of the supply section 40. Hence, the sensor 42 is provided to the inner tube 19e, for instance.

While the configuration of the sensor 42 is not particularly limited as long as temperature can be measured, the measuring time is preferably short. Accordingly, the sensor 42 can make use of, for example, resistance thermometer, radiation thermometer, infrared radiation thermometer and thermistor.

Next, an example of the fine particle production method using the production apparatus 10 above is described below.

First, for example, copper powder having an average particle size of not more than 5 μm is charged into the material supply device 14 as the feedstock powder of the fine particles.

For example, argon gas and hydrogen gas are used as the plasma gas, and a high frequency voltage is applied to the coil 12b for high frequency oscillation to generate the thermal plasma flame 24 in the plasma torch 12.

Further, for instance, argon gas is supplied as the cooling gas in the direction of arrow Q from the gas supply device 28 to the tail portion of the thermal plasma flame 24, i.e., the terminating portion of the thermal plasma flame 24. At that time, argon gas is supplied as the cooling gas in the direction of arrow R.

Next, the copper powder is transported with gas, e.g., argon gas used as the carrier gas and supplied to the thermal plasma flame 24 in the plasma torch 12 through the supply tube 14a. The copper powder supplied is evaporated in the thermal plasma flame 24 to be transformed into a gas phase state and is quenched with the cooling gas, thus producing the primary fine particles 15 of copper.

Then, the primary fine particles 15 of copper thus obtained in the chamber 16 pass through the connection tube 21 and are blown in through the inlet tube 19a of the cyclone 19 together with a gas stream along the inner peripheral wall of the outer tube 19b, and accordingly, this gas stream flows along the inner peripheral wall of the outer tube 19b as indicated by arrow T in FIG. 1, thus forming a swirling stream which goes downward. When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged along the inner wall of the truncated conical part 19c to the outside of the cyclone 19 together with the upward stream on the inner wall.

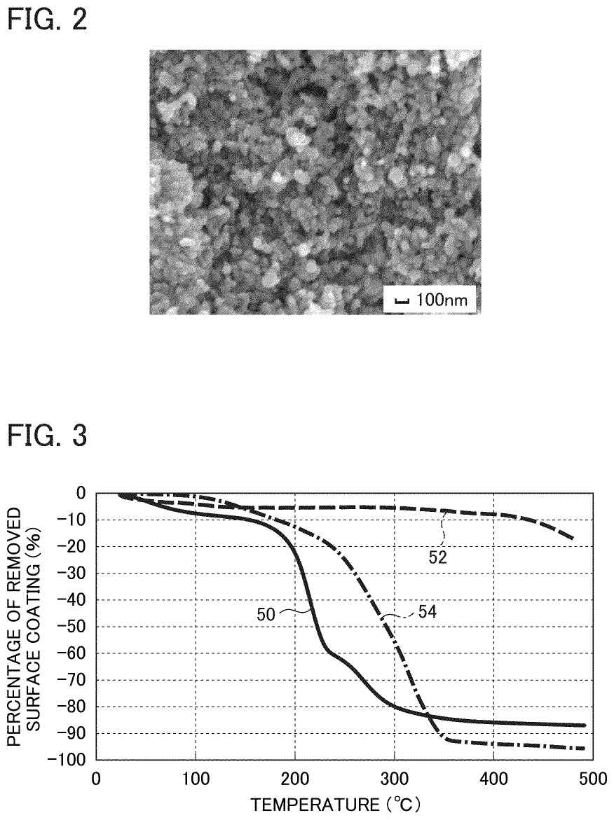

Due to the negative pressure (suction force) applied by the vacuum pump 29 through the collecting section 20, the discharged secondary fine particles 18 are sucked in the direction indicated by arrow U in FIG. 1 to pass through the inner tube 19e. When the secondary fine particles 18 pass through the inner tube 19e, the surface treating agent St in the form of, for example, spray is supplied by the supply section 40 to the secondary fine particles 18, whereby the secondary fine particles 18 are surface treated. The surface treated secondary fine particles 18, i.e., the fine particles 30 are transported to the collecting section 20 and collected by the filter 20b of the collecting section 20. The fine particles shown in FIG. 2, for example, are obtained in this manner.

When the fine particles 30 are collected by the collecting section 20, the internal pressure of the cyclone 19 is preferably equal to or lower than the atmospheric pressure. For the particle size of the fine particles 30, an arbitrary particle size on the order of nanometers is specified according to the intended purpose.

While the primary fine particles of copper are formed using a thermal plasma flame as a heat source in the invention, the primary fine particles of copper may be formed by another gas-phase process. Thus, the method of forming the primary fine particles of copper is not limited to the one using a thermal plasma flame as long as it is a gas-phase process, and may alternatively be one using a flame process, for example. Here, the method of forming the primary fine particles using a thermal plasma flame is called thermal plasma process.

The flame process herein is a method of synthesizing fine particles by using a flame as the heat source and, for instance, putting copper-containing feedstock through the flame. In the flame process, for example, the copper-containing feedstock is supplied to a flame, and then cooling gas is supplied to the flame to decrease the flame temperature and thereby suppress the growth of copper particles, thus obtaining the primary fine particles 15 of copper.

In the flame process, for the cooling gas and the surface treating agent, the same gases and agents as those mentioned for the thermal plasma process described above can also be used.

Next, the fine particles are described.

The fine particles have a particle size of 10 to 200 nm and are surface treated as described above. The surface treated fine particles have the properties based on the properties of the surface treating agent. Hence, for instance, when the surface treating agent is a dispersant having amine value, the fine particles have dispersibility to an acidic solvent or the like. When the surface treating agent is an organic acid being an acidic substance, the fine particles have hydrophilicity or acidity.

While the above particle size of the fine particles is 10 to 200 nm, the particle size of the fine particles is preferably 10 to 150 nm.

The particle size of the fine particles of the invention is the average particle size measured using the BET method.

The fine particles of the invention are not present in a dispersed form in a solvent or the like but are present alone. Therefore, when the fine particles are used in combination with a solvent, there is no particular limitation on the combination with a solvent, and the degree of freedom is high in selection of a solvent.

The surface condition of the surface treated fine particles can be examined using, for instance, a Fourier transform infrared spectrometer (FT-IR).

The fine particles of the invention are produced using the production apparatus 10 described above and using an ethanol solution of terpineol for the surface treating agent. Specifically, the production conditions of the fine particles are as follows. Plasma gas: argon gas (200 liter/min), hydrogen gas (5 liter/min); carrier gas: argon gas (5 liter/min); quenching gas: argon gas (150 liter/min); internal pressure: 40 kPa.

The forgoing surface treating agent is sprayed using a spray gas to the secondary fine particles of copper. The spray gas is argon gas.

FIG. 3 is a graph showing the percentages of removed surface coating on the fine particles obtained with the fine particle production method of the invention. FIG. 3 is provided based on the results obtained in an inert atmosphere by a thermogravimeter-differential thermal analysis (TG-DTA).

Numeral 50 in FIG. 3 represents the fine particles (copper fine particles) of the invention, while numeral 52 and numeral 54 represent the copper fine particles of Conventional Example 1 and terpineol used for the surface treating agent, respectively.

Conventional Example 1 corresponds to the product of the invention with differences of the use of methane gas as the quenching gas and no supply of the surface treating agent in its production; the product can be produced by the same production method as that of the fine particles of the invention except these differences.

As shown in FIG. 3, the percentage of removed surface coating of the fine particles of the invention (see numeral 50) tends to be similar to that of terpineol used for the surface treating agent (see numeral 54). For Conventional Example 1 (see numeral 52), on the other hand, the removal percentage does not change until around temperature of 400° C., having a different trend.

It is evident from the percentage of removed surface coating of the fine particles of the invention (see numeral 50) in FIG. 3 that terpineol used as the surface treating agent is adsorbed to the fine particles of the invention.

An improvement in dispersibility was confirmed by preparing a coating from a dispersant. In general, when solubility of fine particles to a solvent is low, dispersibility becomes poor, the viscosity of the dispersant increases, and it becomes difficult to handle the dispersant. Here, the fine particles of the invention were dispersed in a solvent (terpineol (C₁₀H₁₈O)) to prepare a dispersant, and coating formability thereof on a glass substrate was checked to evaluate solubility of the fine particles to the solvent. In the case of the fine particles of the invention, addition of 0.25 g of the fine particles to 1 g of the solvent succeeded in coating formation, and addition of 0.5 g of the fine particles also did.

The fine particles of Conventional Example 1 were dispersed in a solvent (terpineol (C₁₀H₁₈O)) to prepare a dispersant, and coating formability thereof on a glass substrate was checked to evaluate solubility of the fine particles to the solvent. In the case of the fine particles of Conventional Example 1, addition of 0.25 g of the fine particles to 1 g of the solvent succeeded in coating formation, but addition of 0.5 g of the fine particles did not.

These results reveal that the fine particles of the invention have the improved dispersibility to a solvent, compared with the fine particles of Conventional Example 1.

In the invention, the surface treating agent is supplied to the secondary fine particles in a temperature region in which the surface treating agent is not denatured as described above, whereby the surface treated fine particles can be obtained. Since the surface treated fine particles can be directly obtained in the invention, it is possible to omit surface treatment to particles by means of ordinary post treatment which involves mixing, with a surface treating agent, the surface-untreated particles having been produced and collected, and drying and collecting the resulting particles, and the production process can be simplified. Accordingly, surface treated fine particles can be easily produced in the invention.

Since the properties of the fine particles can be controlled with the properties of the surface treating agent, the fine particles suitable for the intended purpose can be easily produced by changing the surface treating agent.

As an example of application of the surface treated fine particles, when a conductor such as a conductive wire is produced, the fine particles may be mixed with copper particles with a particle size on the order of micrometers to serve as a sintering aid for the copper particles. Alternatively, the surface treated fine particles may be utilized for, in addition to conductors such as conductive wires, those required to have electrical conductivity, and for example, may be used in bonding between semiconductor devices, between a semiconductor device and any of various electronic devices, and between a semiconductor device and a wiring layer.

The present invention is basically as configured above. While the fine particle production apparatus and the fine particle production method according to the invention are described above in detail, the invention is by no means limited to the foregoing embodiments and it should be understood that various improvements and modifications are possible without departing from the scope and spirit of the invention.

### REFERENCE SIGNS LIST

10 fine particle production apparatus
12 plasma torch
14 material supply device
15 primary fine particle
16 chamber
18 secondary fine particle
19 cyclone
20 collecting section
22 plasma gas supply source
22a first gas supply section
22b second gas supply section
24 thermal plasma flame
28 gas supply device
28a first gas supply source
28a second gas supply source
29 vacuum pump
30 surface treated fine particles (fine particles)
40 supply section
42 sensor
St surface treating agent

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A fine particle production apparatus for producing fine particles using feedstock by means of a gas-phase process, the apparatus comprising:
a treatment section configured to transform the feedstock into a mixture in a gas phase state by means of the gas-phase process;
a feedstock supply section configured to supply the feedstock to the treatment section;
a cooling section configured to cool the mixture in the gas phase state in the treatment section using a quenching gas containing an inert gas; and
a supply section configured to supply a surface treating agent to fine particle bodies in a temperature region in which the surface treating agent is not denatured, the fine particle bodies being produced by cooling the mixture in the gas phase state with the quenching gas.

14. The fine particle production apparatus according to claim 13, wherein the gas-phase process is a thermal plasma process or a flame process.

15. The fine particle production apparatus according to claim 13, wherein the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution.

16. The fine particle production apparatus according to claim 14, wherein the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution.

17. The fine particle production apparatus according to claim 13, wherein the feedstock is copper powder.

18. The fine particle production apparatus according to claim 14, wherein the feedstock is copper powder.

19. The fine particle production apparatus according to claim 13, wherein the feedstock supply section supplies the feedstock to the treatment section with the feedstock being dispersed in a particulate form.

20. The fine particle production apparatus according to claim 14, wherein the feedstock supply section supplies the feedstock to the treatment section with the feedstock being dispersed in a particulate form.

21. The fine particle production apparatus according to claim 13, wherein the feedstock supply section disperses the feedstock in liquid to obtain a slurry and transforms the slurry into droplets to supply the droplets to the treatment section.

22. The fine particle production apparatus according to claim 14, wherein the feedstock supply section disperses the feedstock in liquid to obtain a slurry and transforms the slurry into droplets to supply the droplets to the treatment section.

23. A fine particle production method for producing fine particles using feedstock by means of a gas-phase process, the method comprising:
a step of producing fine particle bodies by transforming the feedstock into a mixture in a gas phase state by means of the gas-phase process and cooling the mixture in the gas phase state using a quenching gas containing an inert gas; and
a step of supplying a surface treating agent to the fine particle bodies in a temperature region in which the surface treating agent is not denatured.

24. The fine particle production method according to claim 23, wherein the gas-phase process is a thermal plasma process or a flame process.

25. The fine particle production method according to claim 23, wherein the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution.

26. The fine particle production method according to claim 24, wherein the surface treating agent is an organic acid alone or an organic acid solution, a dispersant having amine value alone or a solution of a dispersant having amine value, a dispersant having acid value alone or a solution of a dispersant having acid value, a dispersant having amine value and acid value alone or a solution of a dispersant having amine value and acid value, a silane coupling agent alone or a silane coupling agent solution, an organic solvent, an acidic substance alone or an acidic substance solution, a basic substance alone or a basic substance solution, a natural resin alone or a natural resin solution, or a synthetic resin alone or a synthetic resin solution.

27. The fine particle production method according to claim 23, wherein the feedstock is copper powder.

28. The fine particle production method according to claim 24, wherein the feedstock is copper powder.

29. The fine particle production method according to claim 23, wherein in the step of producing the fine particle bodies, the feedstock is transformed into the mixture in the gas phase state using a thermal plasma flame, and the feedstock is supplied into the thermal plasma flame with the feedstock being dispersed in a particulate form.

30. The fine particle production method according to claim 24, wherein in the step of producing the fine particle bodies, the feedstock is transformed into the mixture in the gas phase state using a thermal plasma flame, and the feedstock is supplied into the thermal plasma flame with the feedstock being dispersed in a particulate form.

31. The fine particle production method according to claim 23, wherein in the step of producing the fine particle bodies, the feedstock is transformed into the mixture in the gas phase state using a thermal plasma flame, where the feedstock is dispersed in liquid to obtain a slurry, and the slurry is transformed into droplets and supplied into the thermal plasma flame.

32. The fine particle production method according to claim 24, wherein in the step of producing the fine particle bodies, the feedstock is transformed into the mixture in the gas phase state using a thermal plasma flame, where the feedstock is dispersed in liquid to obtain a slurry, and the slurry is transformed into droplets and supplied into the thermal plasma flame.
